(19) United States
(12) Patent Application Publication
(10) Pub. No.: US 2025/0183334 A1
(43) Pub. Date: Jun. 5, 2025

(54) METHOD FOR MANUFACTURING FUEL CELL SEPARATOR WITH INTEGRATED ELASTOMER SEAL

(71) Applicant: ILLUMING POWER INC, Vancouver (CA)

(72) Inventors: Daniel RAMRUS, vancouver (CA); Simon FARRINGTON, Vancouver, CA (US); Christian CAUSSEL, Burnaby (CA)

(21) Appl. No.: 18/844,233

(22) PCT Filed: Feb. 23, 2023
(86) PCT No.: PCT/US2023/013679

§ 371 Date: Sep. 5, 2024

Related U.S. Application Data
(60) Provisional application No. 63/319,136, filed on Mar. 11, 2022.

(51) Int. Cl. H01M 8/0286; H01M 8/0213; H01M 8/0258; H01M 8/0284; H01M 8/10

(52) U.S. Cl. CPC H01M 8/0286; H01M 8/0213; H01M 8/0258; H01M 8/0284; H01M 2008/1095

(57) ABSTRACT

A simple, fast method for manufacturing a fuel cell separator with integrated elastomer seal has been developed using a UV-curable elastomer composition for the seal. A mold for the seal comprising a flexible sheet made of PTFE or polystyrene is employed. The mold is compressed against a separator plate between a support and a UV-transparent clamping block. Elastomer is then appropriately injected and cured using UV light. Thereafter, the flexible sheet is peeled off, rather than removed all at once, thereby avoiding delamination of the fragile seal from the separator plate.

### TECHNICAL FIELD

This invention pertains to manufacturing methods for fuel cell separators. In particular, it pertains to methods for making separators with integrated elastomer seals for use in solid polymer electrolyte fuel cells.

### BACKGROUND

Fuel cells have been used in niche applications for decades but continue to show promise for numerous other applications where electrical power is required. They are generally considered clean (green) with desirable efficiency and safety characteristics. Cost continues to be a challenge however since certain materials used can be expensive and certain components are complex in design and expensive to manufacture. One such component can be the separators or separator plates used in fuel cell stacks and particularly in solid polymer electrolyte fuel cell stacks.

There are several types of fuel cell designs, including high operating temperature types such as solid oxide fuel cells along with lower operating temperature types such as alkaline fuel cells. Solid polymer electrolyte fuel cells are of the latter type and are preferred for use in motive power applications such as automobiles, ships, and trains. Such fuel cells electrochemically convert fuel (typically hydrogen) and oxidant (typically oxygen) to generate electric power. They generally employ a proton conducting polymer membrane electrolyte between two electrodes, namely a cathode and an anode. The cathode and anode electrodes comprise appropriate catalysts to accelerate the desired reactions taking place in the fuel cell. Frequently, the cathodes and anodes are applied directly to the membrane electrolytes to form unitary assemblies known as catalyst coated membrane assemblies (CCMs). Gas diffusion layers (typically porous, electrically conductive layers comprising carbon fibers or the like) are provided adjacent the electrode surfaces of the CCM in order to improve the distribution of fluids to and from the electrodes during operation. Structures comprising a CCM sandwiched between two gas diffusion layers electrodes are known as a membrane electrode assembly (MEA). In a typical solid polymer electrolyte fuel cell, flow field plates comprising numerous fluid distribution channels for the reactants are provided on either side of a MEA to deliver fuel and oxidant firstly to the respective gas diffusion layers and then the electrodes in the cell and then to remove by-products of the electrochemical reactions taking place within the cell. Water is the primary by-product in a cell operating on hydrogen and air reactants and typically operating temperatures range from around 80 to 100° C. Because the output voltage of a single cell is of order of 1V, a plurality of cells is usually stacked together in series for commercial applications. Individual cells in such stacks are separated from each other using separator plates of some kind. For efficiency and convenience, the flow field plates typically also serve as such separator plates too. Fuel cell stacks can be further connected in arrays of interconnected stacks in series and/or parallel for use in automotive applications and the like.

Along with water, heat is a significant by-product from the electrochemical reactions taking place within the fuel cell. Means for cooling a fuel cell stack is thus generally required. Stacks designed to achieve high power density (e.g. automotive stacks) typically circulate liquid coolant throughout the stack in order to remove heat quickly and efficiently. To accomplish this, coolant flow fields comprising numerous coolant channels are also typically incorporated in the flow field plates (or separator plates) of the cells in the stacks. The coolant flow fields may be formed on the electrochemically inactive surfaces of the flow field plates and thus can distribute coolant evenly throughout the cells while keeping the coolant reliably separated from the reactants.

Bipolar separator plate assemblies comprising an anode flow field plate and a cathode flow field plate which have been bonded and appropriately sealed together so as to form a sealed coolant flow field between the plates are thus commonly employed in the art. Various transition channels, ports, ducts, and other features involving all three operating fluids (i.e. fuel, oxidant, and coolant) may also appear on the inactive side of these plates. The operating fluids may be provided under significant pressure and thus all the features in the plates must be sealed appropriately to prevent leaks between the fluids and to the external environment. The bipolar separator plates must be chemically resistant against these fluids at elevated temperatures. A further requirement for bipolar separator plate assemblies is that there is a satisfactory electrical connection between the two plates. This is because the substantial current generated by the fuel cell stack must pass between the two plates.

Numerous variants of flow field plate designs and materials of bipolar separator plate assemblies appear in the art. The plates and/or assemblies may optionally be metallic, in which case they are typically formed using a variety of stamping steps from a sheet or sheets of suitable specialty metals. These are subsequently welded or adhesively bonded and sealed together so as to appropriately seal all the fluid passages from each other and from the external environment.

Flow field (separator) plates and bipolar separator plate assemblies may also optionally be made of carbon. Carbon can be a preferred material for such applications because of its desirably high corrosion resistance, good electrical conductivity, relative ease of manufacture and relative low cost. Flexible graphite or expanded graphite sheets and the like are commonly used as substrates for manufacturing flow field plates for fuel cells. These carbon sheets are readily handled, and complex structures can easily be embossed therein. They are however porous and must be impregnated with a suitable filler or monomer composition to suitably seal the plates and prevent liquids or gases from leaking through. Further, the cured, impregnated monomer composition is also required to impart additional other desirable mechanical properties to the product flow field plates, including stiffness over a range of fuel cell operating temperatures. A high glass transition temperature, Tg, is thus considered desirable.

As is evident from the above, the design of typical flow field/separator plates and assemblies for solid polymer electrolyte fuel cell stacks is quite complex. For reduced volume and increased energy density, such plates are generally thin and fragile. Numerous reliable seals are required not only between the plates making up the bipolar plate assemblies but also between the adjacent cells in an assembled fuel cell stack. To simplify the assembly of a stack of cells, the seals employed are preferably attached to or integrated on one of the separator plates (or bipolar separator plate assemblies as the case may be) associated with each individual cell in the stack.

There are limited options for the seal materials which can be used in typical solid polymer electrolyte fuel cells due to the numerous mechanical and chemical properties required for long term, reliable functioning. Silicone and polyisobutylene (PIB) elastomers are commonly used in this regard. For instance, U.S. Pat. No. 7,686,854 discusses the use of silicone compositions for use in seals. A typical prior art approach for incorporating silicone seals directly onto a separator plate has been to mold a suitable liquid silicone composition onto a plate using liquid injection molding (LIM) techniques. The composition is then typically cured at elevated temperature. However these LIM methods have a few drawbacks including: the high injection pressures employed can break the thin and relatively plates especially because they are more fragile at elevated temperatures; the high clamping pressures employed to seal the mold to the plate during processing can also break the plates especially again because they are more fragile at elevated temperatures; and the required heat curing process results in a slow production cycle time, especially when compared to faster curing processes such as UV curing

In this regard, it is well known that various elastomers, including silicone elastomers, can be quickly cured by exposing suitable precursor compositions to UV light. “Silicone rubber is cured quickly by UV light”, Sealing Technology Volume 2009, Issue 11, November 2009, Page 2. While UV curing processes can be desirable, there are significant limits on the material options and thickness (and hence on coating capability) for suitable molds because substantial UV transmissibility through the molds must be maintained. Nonetheless, various mold materials (including polymethyl methacrylate or PMMA and PTFE) and/or UV curing techniques have desirably been used to apply various plastics (including epoxies, elastomers, etc.) onto other substrates (e.g. as disclosed in US2005/0167894 or EP1700680).

In US20090004541, techniques were suggested for applying seals to fuel cell components (including flow field plates) using PIB elastomer seal materials and methods involving UV curing and UV transparent molds. The prior art techniques of U.S. Pat. Nos. 6,057,054 and 5,264,299 for molding silicone seals onto MEAs and plates were discussed. As disclosed, the mold member is desirably transparent, i.e., transmissible or substantially transmissible, to actinic radiation, for example UV radiation. Optionally, a release agent (e.g. dry PTFE spray, spray-on oils, etc.) may be applied prior to the introduction of the liquid composition which is employed, if needed, to help in the easy removal of the cured gasket from the mold cavity. The use of release agents is generally not preferred though because they are consumables, thereby increasing cost, they are difficult to apply into recessed features, and the release agent ends up on the product part. The Examples disclose the preparation of certain formulations and several UV-cured polyisobutylene/silane samples.

Notwithstanding the numerous advancements made to date in the economic, efficient production of fuel cell components and commercial fuel cell stacks, there remains a need for improvements in manufacturing methods to more reliably and more quickly produce these items. This invention fulfills these needs and provides further related advantages as disclosed below.

### SUMMARY

Manufacturing methods that are more suitable for commercial production have been developed for making fuel cell separators with integrated elastomer seals. The methods are simple and fast and involve the UV curing of UV-curable elastomer compositions molded directly onto the separators. Importantly, the methods allow for the removal of the related molds without delaminating or damaging the fragile integrated seals. The methods are particularly suitable for use in the production of separators with integrated seals for use in solid polymer electrolyte fuel cells.

Specifically, a method of the invention comprises obtaining a non-porous plate (i.e. the desired separator), placing the plate on a suitable support such that the surface of the plate opposite the intended seal surface is adjacent the support, and placing a mold for the seal against the intended seal surface of the plate. The mold comprises a flexible sheet made either of polytetrafluoroethylene (PTFE) or polystyrene, a cavity for the seal formed on the flexible sheet surface adjacent the intended seal surface of the non-porous plate, and at least one injection port fluidly connected to the cavity. The method then further comprises placing a UV-transparent clamping block against the mold, compressing the UV-transparent clamping block towards the support such that the flexible sheet seals against the intended seal surface of the plate, injecting a UV-curable elastomer composition into the injection port and into the cavity, shining UV light through the UV-transparent clamping block and through the mold such that the injected elastomer composition is cured, removing the clamping block from the mold, and finally peeling the flexible sheet off the plate.

In the method, the non-porous plate can be selected from the group consisting of graphite, expanded graphite, impregnated expanded graphite, porous carbon foam, porous carbon, carbon, carbon composites, and metal foil.

The method is appropriate for use on various types of non-porous fuel cell separators, including those of single plates or bipolar plate assemblies. Further, it is appropriate for separators comprising flow fields formed on one or both surfaces and particularly for separators comprising inlet and outlet ports for the various reactants and coolants used in typical assembled fuel cell stacks. The thicknesses of the associated non-porous plates typically can range from as low as 0.1 mm for separators having no flow fields formed in them to 2.0 mm thick for separators with flow fields formed on both surfaces.

The thickness of an exemplary flexible sheet for use in the method can be from 0.5 to 3 mm. The depth of an exemplary cavity in the associated mold can be from 0.3 to 1.5 mm.

Suitable material choices for the UV-transparent clamping block involved include polymethyl methacrylate (PMMA) or glass. Suitable UV-curable elastomer compositions include silicone precursors and polyisobutylene precursors. And suitable wavelengths for the UV light involved in the shining step and hence the curing step are in the range from 250 to 500 nm.

These and other aspects of the invention are evident upon reference to the following detailed description.

### BRIEF DESCRIPTION OF THE DRAWINGS

FIG. 1a shows an isometric view of an exemplary bipolar separator comprising a flow field, fluid ports, and integrated seal for a solid polymer electrolyte fuel cell.

FIG. 1b shows a cross-section along line A-A of the bipolar separator shown in FIG. 1a.

FIGS. 2a through 2e show schematics of the various steps generally involved in the method of the invention. For illustrative purposes, the separator shown is similar to the bipolar separator shown in FIGS. 1a and 1b.

Specifically, FIG. 2a shows the initial obtaining and placing steps of certain components involved.

FIG. 2b shows the injecting step.

FIG. 2c shows the UV-shining step which accomplishes curing.

FIG. 2d shows the peeling step after the clamping block has been removed (not shown).

FIG. 2e shows the manufactured bipolar separator.

### DETAILED DESCRIPTION

Unless the context requires otherwise, throughout this specification and claims, the words “comprise”, “comprising” and the like are to be construed in an open, inclusive sense. The words “a”, “an”, and the like are to be considered as meaning at least one and are not limited to just one.

Further, the following definitions have been used herein.

Herein, “PTFE” stands for polytetrafluoroethylene.

In the context of the present disclosure, a “flexible sheet” is defined as a sheet whose thickness ranges up to 15 mm. PTFE and/or polystyrene sheets in this range flex sufficiently such that the stress exerted on a fragile seal (which has just been injection molded and cured onto a separator plate) is sufficiently small to avoid delaminating the seal from the plate as the sheet is peeled therefrom. (For reference, PTFE and polystyrene have a Young's modulus of 400 and 3250 MPa respectively. The flex obtained will be a function of this modulus and the sheet thickness.)

The method of the invention represents an improvement means for manufacturing fuel cell separators with integrated elastomer seals. It is simple, fast, and reliable and involves using a UV-curable elastomer composition for the seals and UV curing techniques to apply the seals to the separator.

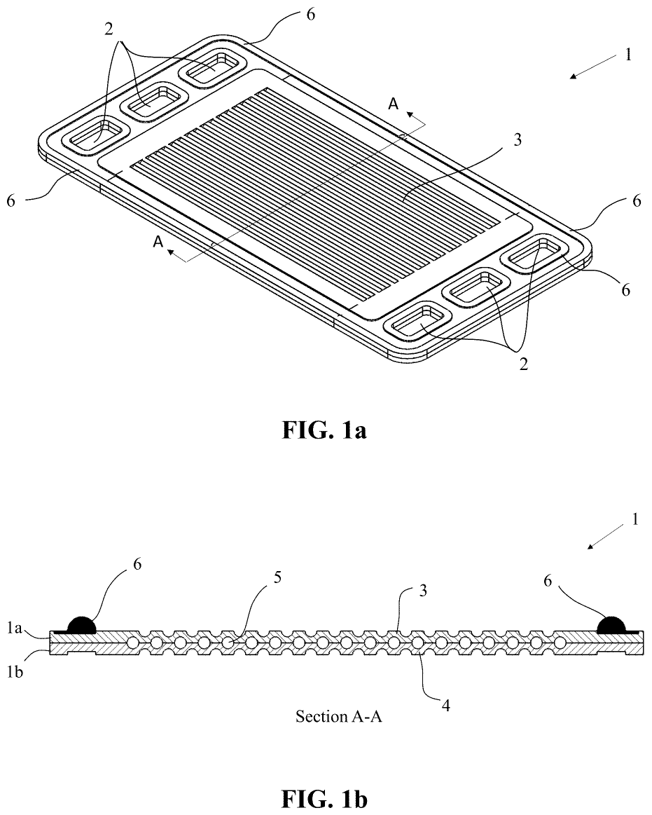

FIGS. 1a and 1b show views of an exemplary expanded graphite bipolar separator with an integrated seal intended for use in a solid polymer electrolyte fuel cell. FIG. 1a and 1b show an isometric view and a cross-sectional view along line A-A respectively of bipolar separator 1. Bipolar separator 1 comprises cathode flow field plate (or separator) 1a and anode flow field plate (or separator) 1b which are bonded together to form a unitary bipolar separator. Both cathode and anode flow field plates 1a, 1b comprise 2 ports for the inlets and outlets of the fluids (i.e. fuel, oxidant, and coolant) supplied to and removed from an assembled fuel cell stack. Further, channels have been formed on one surface of cathode flow field plate 1a to create cathode flow field 3 and on the opposite surface to create part of coolant flow field 5. In a like manner, channels have also been formed on one surface of anode flow field plate 1b to create anode flow field 4 and on the opposite surface to create the other part of coolant flow field 5.

Also appearing in FIGS. 1a and 1b is elastomer seal 6 which has been integrated (attached to) cathode flow field plate 1a of bipolar separator 1. Elastomer seal 6 is complex in shape and includes sealing portions around ports 2, as well as the periphery of cathode flow field plate 1a, and can also include sealing portions in other regions if/as desired (e.g. around transition regions or other special features. Due to the nature of the materials employed (for instance, carbon for cathode flow field plate 1a and silicone for elastomer seal 6) and the small thicknesses of the components (typically a few millimeters at most), the bond between cathode flow field plate 1a and elastomer seal 6 is quite fragile and easily disrupted or damaged.

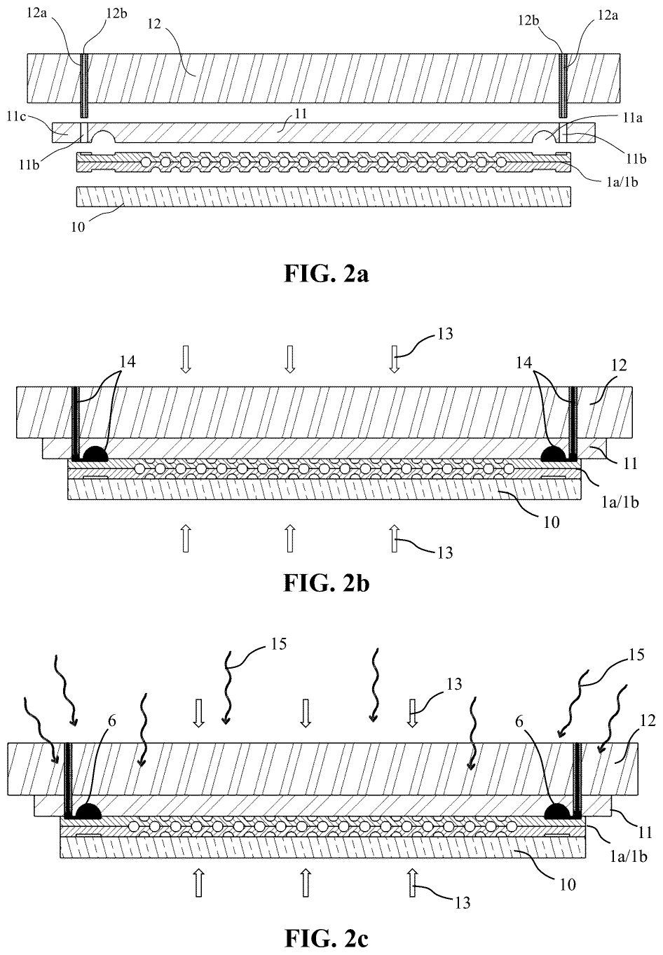

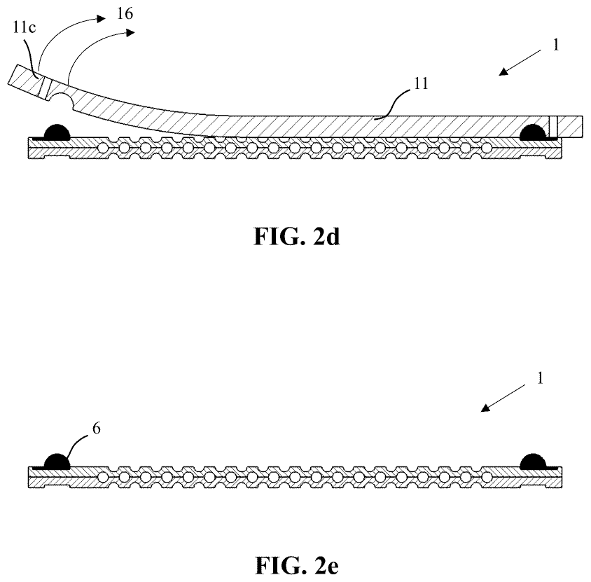

FIGS. 2a through 2e show schematics of how the exemplary bipolar separator with integrated seal of FIGS. 1a and 1b can be made in accordance with the invention. Initially, the non-porous plate to which the seal is to be integrated with is obtained. Here, this non-porous plate is the bipolar separator comprising unitary cathode flow field plate 1a and anode flow field plate 1b, hereafter referred to as plate 1a/1b. As shown now in FIG. 2a, plate 1a/1b is placed on support 10 such that its surface opposite the intended seal surface is adjacent support 10. Mold 11 is placed against the intended seal surface of plate 1a/1b. In this particular example, mold 11 is a single piece, namely a flexible PTFE sheet. (However, in other embodiments of the invention, mold 11 may be a flexible polystyrene sheet and/or a flexible sheet with both PTFE and polystyrene components. Further, mold 11 may also comprise certain other elements for additional mechanical purposes.) Mold/flexible PTFE sheet 11 comprises cavity 11a for the seal and injection ports 11b fluidly connected to cavity 11a to allow for access of injected silicone elastomer composition to cavity 11a. Note that in these figures, injection ports 11b are shown as straight cylindrical openings. While satisfactory results can be obtained therewith (as confirmed by experimental trials), in alternative embodiments, modestly cone shaped injection ports may be employed to allow for easier demolding (i.e. detachment from the sprue formed after curing).

Also note that injection ports 11b are slightly offset from the bulk of seal 6 so that this sprue can be easily accessed and removed and that it is in a location not affecting seal function. Further, mold/flexible PTFE sheet 11 comprises machine pullable tab 11c which can be grabbed and pulled by appropriate mechanical means for the later peeling step involved in the method. Finally as shown, UV-transparent clamping block 12 is placed against mold/flexible PTFE sheet 11. UV-transparent clamping block 12 comprises two injection ports 12b which are for the same purpose as injection ports 11b and are aligned therewith. UV-blocking sleeves 12a are provided around injection ports 12b to prevent UV radiation from curing injected elastomer composition in injection ports 12b (additional explanation appears below). As shown in these figures, UV-blocking sleeves 12a have optionally been made long enough to extend into flexible PTFE sheet 11 during the compressing, injecting and UV shining steps. In alternative embodiments however, UV-blocking sleeves 12a may be just long enough to extend through the thickness of UV-transparent clamping block 12.

The schematic shown in FIG. 2b depicts the compressing and injection steps involved in the general method of the invention. Here, UV-transparent clamping block 12 is compressed towards support 10 (shown by arrows 13) such that mold/PTFE sheet 11 seals against the intended seal surface of plate 1a/1b. (The compressing means, such as a press, is not shown in these figures.) Next, the desired UV-curable elastomer composition 14 is injected into injection ports 12b, through injection ports 11b, and into cavity 11a thereby shaping seal 6. (The injecting means, such as a pump, is not shown in these figures.)

Next, and as shown in the schematic of FIG. 2c, UV light 15 of an appropriate wavelength is shone through both UV-transparent clamping block 12 and inherently UV-transparent flexible PTFE sheet 11 for a sufficient time so as to cure injected elastomer composition 14 and thereby form cured elastomer seal 6 and thereby integrate it onto plate 1a/1b. Because the mold/flexible PTFE sheet 11 is inherently UV transparent, the elastomer composition in injection ports 11b is also cured by the UV light. However, because injection ports 12b are shielded from the UV light by UV-blocking sleeves 12a, the elastomer composition in injection ports 12b remains uncured and fluid. Consequently, cured elastomer in injection ports 12b does not have to be removed from UV-transparent clamping block 12 before it is ready for use again.

With seal 6 now formed and integrated onto plate 1a/1b, UV-transparent clamping block 12 is removed from mold/flexible PTFE sheet 11 and, as depicted in FIG. 2d, flexible PTFE sheet 11 is peeled off plate 1a/1b. The peeling can be accomplished using suitable mechanical means (not shown) to grab machine pullable tab 11c and pull it away from plate 11a/11b at a desirable angle along a desirable path (shown by arrows 16). The angle and path, along with the speed of peeling, are selected such that sheet 11 is modestly flexed and disengages from plate 11a/11b in a smooth, steady manner from left to right as shown in FIG. 2d. With proper selection of these parameters, flexible PTFE sheet 11 can be reliably and relatively quickly removed without damaging or delaminating seal 6 from plate 11a/11b. And of course, in order to be able to modestly flex PTFE sheet 11, it must be selected to be thin enough so as to be able to flex in such a manner. With the peeling step done, manufacture of bipolar separator with integrated seal 1 is complete as depicted in FIG. 2e (and similar to that shown in FIG. 1b).

As is evident from the preceding, the method of the invention is very simple and requires very few steps. Both the clamping pressure and the injection pressure employed can be significantly less than those used for conventional LIM techniques thereby significantly reducing the chance of breaking the separator plates during processing, especially at the higher temperatures used in heat curing. For instance, clamping pressures of order of 0.5-4 tons and injection pressures of 1-30 bar order of may be used in the present method rather than the approximate 20-80 tons and 100-150 bar typically used respectively in LIM processing. Further, and very advantageously, the time needed to inject and adequately cure the elastomer composition using the present UV curing method is substantially faster than using typical heat curing methods. For instance, only about 2-10 seconds is required for the former while 30-60 seconds is typically required for the latter. Further still, and importantly, there can be significant adhesion of the seal material to the mold during processing using prior art methods. This adhesion results in problems demolding a seal from the mold cavity without delaminating the seal from the plate. The present invention however overcomes this problem essentially by demolding the seal from the cavity progressively and reliably by peeling it away, thereby preventing delamination and damage.

While the preceding disclosure is mainly directed at integrating a silicone elastomer seal onto a carbon bipolar separator intended for use in solid polymer electrolyte fuel cells, those of ordinary skill appreciate that the invention has the potential for much wider applications. For instance, it can advantageously be used for manufacture of other fuel cell types (e.g. alkaline fuel cells). In addition, the non-porous plate or plates involved may not only be made of carbon (such as graphite, expanded graphite, impregnated expanded graphite, porous carbon foam, porous carbon, carbon, carbon composites, and so forth) but also made of alternative conventional materials such as metal foil. Further, the invention is applicable for use with separators comprising a single plate as well as bipolar separators comprising two or more plates. Further still, the invention is applicable for use with separators either with flow fields and/or ports incorporated therein or without such incorporated flow fields and/or ports. Typically, then the thickness of such plate options is from about 0.1 to 2.0 mm. Outside of fuel cell applications, this technology could be used to apply seals to virtually any component that currently uses LIM of elastomeric materials.

In addition, any elastomer compositions that are compatible for use in the intended fuel cell application and which are UV-curable may be considered. Along with silicone precursors then, the elastomer composition used may instead be a polyisobutylene precursor or other suitable composition. And while UV light with wavelengths in the range from 250 to 500 nm may be preferred for curing certain silicone precursors, other more suitable wavelengths should be considered depending on the composition employed.

As for the hardware used in the method, any flexible PTFE and/or polystyrene sheet as defined above may be contemplated for use, for example by using reinforcements made out of glass beads or fibers.

In exemplary embodiments though, an acceptable thickness appears to be from 0.5 to 3 mm. The depths of the cavities used (and hence size of the seals formed) in such sheets can then be from about 0.3 to 1.5 mm. And various materials (e.g. PMMA or glass) and thicknesses for the UV-transparent clamping block may be considered as long as it allows for sufficient UV transmission therethrough and is mechanically and chemically suitable for clamping, compressing, and injection purposes.

Those skilled in the art will appreciate that, in addition to the preceding, many other variations are possible while still being able to obtain the benefits of the present invention.

The following examples are illustrative of the invention but should not be construed as limiting in any way.

### EXAMPLES

In the following, attempts were made to prepare a number of sections of bipolar separators with integrated silicone elastomer seals similar to those shown in FIGS. 1a and 1b. The non-porous plate sections all were taken from the ends of single flow field plates, and thus included all the seals in and around the fluid ports. The non-porous plate sections were resin impregnated, expanded graphite foil about 500×200×1.4 mm in size.

PIB was used as the elastomer precursor and the groove depth in each of the mold cavities used was about 0.25 mm deep. Compression pressures of approximately hundreds of pounds (as opposed to tons as is typically used in LIM molding) were used to clamp assemblies together during injection molding. UV light with an average wavelength of about 405 nm was shone around the injection ports and through the molds and clamping blocks for about 30 seconds to cure the injected elastomer samples.

### Comparative Examples

Attempts were made to prepare separator sections with integrated seals as shown generally in FIGS. 2a through 2e using a mold made of PMMA and PTFE mold release spray as suggested in the prior art. The PMMA mold was about 6.4 mm thick and a 0.6 mm deep grooved cavity for the seal was formed therein. An aluminum block was used as a support and samples were prepared by injecting seal material until the cavity was full and the seal material was then cured. When the separator sections were removed from the mold, partial delaminations of the applied seals occurred.

### Inventive Examples

Four exemplary separator sections with integrated seals were prepared in accordance with the invention and as shown generally in FIGS. 2a through 2e. Two of the exemplary sections were made of expanded graphite which was embossed and impregnated with a resin which was cured to make a rigid part. The other two samples were made of carbon particles which were fused with a resin in a heated compression molding process. Here, a 2.0 mm PTFE sheet was used as the flexible sheet in which a 0.6 mm deep grooved cavity for the seal was formed therein. The clamping block used was 32 mm thick PMMA and an aluminum block was used as a support. In each case, the seal was injected until the cavity was full after which the seal material was cured using UV light. Then the separator section with applied flexible sheet was removed from the mold and the separator section placed on a flat surface. The flexible sheet was slowly bent upwards starting at a corner whereupon the flexible sheet separated cleanly from the separator section while leaving the seal fully integrated thereto.

Additional exemplary separator sections with integrated seals were prepared in a like manner to the preceding except that a 2.0 mm polystyrene sheet was used as the flexible sheet instead of a PTFE sheet. Again, in each case, the seal was injected until the cavity was full. The separator section with applied flexible sheet was then removed from the mold and placed on a flat surface. The flexible sheet was slowly bent upwards starting at a corner whereupon, once again, the flexible sheet separated cleanly from the separator section while leaving the seal fully integrated thereto.

All of the above U.S. patents, U.S. patent application publications, U.S. patent applications, foreign patents, foreign patent applications and non-patent publications referred to in this specification, are incorporated herein by reference in their entirety.

While particular elements, embodiments and applications of the present invention have been shown and described, it will be understood, of course, that the invention is not limited thereto since modifications may be made by those skilled in the art without departing from the spirit and scope of the present disclosure, particularly in light of the foregoing teachings. Such modifications are to be considered within the purview and scope of the claims appended hereto.

1. A method for manufacturing a fuel cell separator with integrated elastomer seal comprising:
obtaining a non-porous plate;
placing the plate on a support such that the surface of the plate opposite the intended seal surface is adjacent the support;
placing a mold for the seal against the intended seal surface of the plate wherein the mold comprises:
a flexible sheet up to 15 mm in thickness comprising PTFE or polystyrene;
a cavity for the seal formed on the flexible sheet surface adjacent the intended seal surface of the plate; and
at least one injection port fluidly connected to the cavity;
placing a UV-transparent clamping block against the mold;
compressing the UV-transparent clamping block towards the support such that the flexible sheet seals against the intended seal surface of the plate;
injecting a UV-curable elastomer composition into the injection port and into the cavity;
shining UV light through the UV-transparent clamping block and through the mold such that the injected elastomer composition is cured;
removing the clamping block from the mold; and
progressively peeling the flexible sheet off the plate.

2. The method of claim 1 wherein the non-porous plate is made of graphite, expanded graphite, impregnated expanded graphite, porous carbon foam, porous carbon, carbon, carbon composites, or metal foil.

3. The method of claim 1 wherein the thickness of the non-porous plate is from 0.1 to 2.0 mm.

4. The method of claim 1 wherein the thickness of the flexible sheet is from 0.5 to 3 mm.

5. The method of claim 1 wherein the depth of the cavity is from 0.3 to 1.5 mm.

6. The method of claim 1 wherein the UV-transparent clamping block is selected from the group consisting of PMMA and glass.

7. The method of claim 1 wherein the UV-curable elastomer composition is selected from the group consisting of silicone precursors and polyisobutylene precursors.

8. The method of claim 1 wherein the wavelength of the UV light in the shining step is in the range from 250 to 500 nm.

9. The method of claim 1 wherein the fuel cell separator comprises ports and a flow field formed on a surface of the non-porous plate.

10. The method of claim 1 wherein the fuel cell is a solid polymer electrolyte fuel cell.
